(19) United States
(12) Patent Application Publication
(10) Pub. No.: US 2011/0225496 A1
(43) Pub. Date: Sep. 15, 2011

(54) SUGGESTED PLAYLIST

(76) Inventors: Peter Jeffe, Austin, TX (US); Sandeep Mathur, Austin, TX (US)

(21) Appl. No.: 13/046,974

(22) Filed: Mar. 14, 2011

Related U.S. Application Data
(60) Provisional application No. 61/313,537, filed on Mar. 12, 2010.

(51) Int. Cl. G06F 3/00

(52) U.S. Cl. 715/716

(57) ABSTRACT

Disclosed herein are method and systems for creating suggested playlists for users. In some embodiments, such playlists may be automatically created for users where the suggested playlists are created for a user based on one or more selection criteria or preferences of the user, including local and/or remote pieces of media.

### PRIORITY CLAIM

This application claims priority to U.S. Provisional Patent Application Ser. No. 61/313,537 entitled “SUGGESTED PLAYLIST”, filed on Mar. 12, 2010, which is hereby incorporated by reference in its entirety as though fully and completely set forth herein.

### BACKGROUND OF THE INVENTION

1. Field of the Invention

This disclosure relates generally to the field of creating suggested playlists for users and, more specifically, this disclosure pertains to the field of automatically creating suggested playlists for users where creating suggested playlists for a user is based on one or more selection criteria or preferences of the user and includes local and/or remote pieces of media.

2. Description of the Relevant Art

Creating suggested playlists for users have been used in streaming, over the Internet, musical content to a user based on a musical preference of the user. In one example, a streaming music service, such as Pandora, streams multiple songs, through the Internet, to a user based on how well the user likes a particular song.

### SUMMARY OF THE INVENTION

In one or more embodiments, a media selection and playing system can create media viewing and/or listening sessions from one or more methods and/or systems described herein. In one or more embodiments, a media list (e.g., a playlist) can be created and/or stored based on a selection of one or more pieces of media. In one example, a user may start listening to a song and/or watch a video, and a media list can be created based on the song and/or video.

In one or more embodiments, one or more subsequent user selections can be used to create a new media list and/or modify an existing media list. In one example, the user can actively select (e.g., by selecting a button and/or icon) one or more pieces of media from a media list as a positive indication associated with the one or more pieces of media. In a second example, the user can passively select one or more pieces media from a media list as a positive indication associated with the one or more pieces of media. For instance, the user can passively select the one or more pieces of media from the media list as the positive indication by allowing the media to be played for an amount of time (e.g., a song and/or video being played for thirty seconds). In a third example, the user can actively select (e.g., by selecting a button and/or icon) one or more pieces of media from a media list as a negative indication associated with the one or more pieces of media. In a fourth example, the user can passively select the one or more pieces of media from the media list as the negative indication by skipping and/or advancing to a next piece of media before an amount of time transpires (e.g., a song and/or video being played for less than twenty seconds).

In one or more embodiments, a list of recommended one or more pieces of media can be made from one or more of media from user storage (e.g., stored in a memory of a computing device associated with the user), media that can be streamed to the user, and/or media that can be downloaded for storage on a computing device associated with the user. In one example, a media list can be created from media stored on one or more of a mobile wireless telephone (e.g., a cellular telephone, a satellite telephone, etc.), a computing device, and a portable media player (e.g., an iPod, a MP3 player, etc.) associated with the user. In a second example, a media list can be created from media stored on a server. In one instance, the media of the media list can be streamed (e.g., via a network) to one or more of a mobile telephone, a computing device, and a portable media player associated with the user. In another instance, the media of the media list can be downloaded (e.g., via a network) to one or more of a mobile wireless telephone, a computing device, and a portable media player associated with the user. For example, the user may purchase one or more pieces of media of the media list and the purchased one or more media can be downloaded from a server to one or more of a mobile wireless telephone, a computing device, and a portable media player associated with the user.

In one or more embodiments, after the user starts playing one or more pieces of media (e.g., one or more of songs, albums, media from a playlist, and videos, etc.), a system (e.g., a computer system such as a server or a computing device) can create and/or insert multiple recommended pieces of media into the user's listening and/or viewing queue. In one example, the recommended pieces of media in the queue can be controlled by a server. For instance, the server can be configured to allow for the recommendations to be updated based on the user's feedback and/or feedback from other users. In another example, the computing device associated with the user can be configured to allow for the recommendations to be updated based on the user's feedback and/or feedback from other users. In one or more embodiments, a database of affinities among/between pieces of media can be developed and/or created where one or more users indicate one or more opinions of which pieces of media go well together. In one or more embodiments, the database of affinities among/between pieces of media can be stored on a server and/or a computing device associated with a user.

In one or more embodiments, the recommended media can come from one or more of a user's local collection (e.g., pieces of media stored on the computing device associated with the user) and one or more remote sources such as one or more subscription services (e.g., Radioio, Rhapsody, Virgin Digital, Hulu, Netflix, etc.) and/or one or more media online purchase services (e.g., iTunes, AmazonMP3, etc.). For example, pieces of media from the user's local collection and pieces of media from the one or more remote sources can be interleaved in a media list. In one or more embodiments, a media list can be created from only local pieces of media. For example, a user may not have a network connection, and the system can create a media list with only local media. In one or more embodiments, a media list can be created from only remote pieces of media. For example, the remote media can be mixed from any number of sources (e.g., different vendor catalogs, different subscription services, etc.). In one or more embodiments, a user's ratings of remote songs can affect recommendations for local pieces of media and/or remote pieces of media.

In one or more embodiments, one or more systems and/or methods can provide and/or use one or more frameworks that can allow for use of media list creation and/or use when network communication is unreliable and/or non-existent for one or more periods of time. In one example, a user's ratings can be stored on computing device associated with the user and communicate (e.g., via a network) with a server when communications are available. In another example, recommendations, created by a server, can be stored via the server and communicated (e.g., via a network) to computing device associated with the user when communications are available.

In one or more embodiments, one or more systems and/or methods can use fuzzy matching and/or audio fingerprinting techniques to identify one or more pieces of media with poor or non-existent tags (e.g., artist, title, album, etc.). For example, one or more recommendations may not be made without identifying a song, video, or media that a user started. In one or more embodiments, one or more systems and/or methods described herein can use a combination of fuzzy text matching logic and/or audio fingerprinting to identify media.

In one or more embodiments, one or more systems and/or methods can convert one or more musical works (e.g., songs) into one or more videos. For example, a user can start from one or more musical works, and one or more systems and/or methods can, in an automated fashion, search for and/or acquire one or more videos that correspond to each of the one or more musical works without the user searching for and/or acquiring each of the one or more videos. For instance, one or more systems and/or methods can receive a music playlist (e.g., a group of songs) from a user and provide a corresponding video playlist (e.g., a group of videos) to the user via a computing device associated with the user.

### BRIEF DESCRIPTION OF THE DRAWINGS

The embodiments of the disclosure will become apparent upon reading the following detailed description and upon reference to the accompanying drawings in which:

FIG. 1 is a block diagram of one or more network communications systems, according to one or more embodiments;

FIG. 2 is a block diagram of one or more network communications systems, according to one or more embodiments;

FIG. 3 is a block diagram of a computing device, according to one or more embodiments;

FIG. 4 is a block diagram of a server computing device, according to one or more embodiments;

FIGS. 5-20 are block diagrams of a display or window of an application, according to one or more embodiments;

FIG. 21 illustrates a method of generating a first list of recommended pieces of media, according to one or more embodiments;

FIG. 22 illustrates a method of generating a second list of recommended pieces of media, according to one or more embodiments; and

FIG. 23 illustrates a method of using a playlist to search for videos, according to one or more embodiments.

While the embodiments described herein may be susceptible to one or more modifications and/or one or more alternative forms, specific embodiments thereof are shown by way of example in the drawings and will herein be described in detail. It should be understood, however, that the drawings and detailed description thereto are not intended to limit the disclosure to the particular form disclosed, but on the contrary, the disclosure is to cover all modifications, equivalents and/or alternatives.

### DETAILED DESCRIPTION OF THE PREFERRED EMBODIMENTS

It is to be understood the present invention is not limited to particular devices or systems, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise.

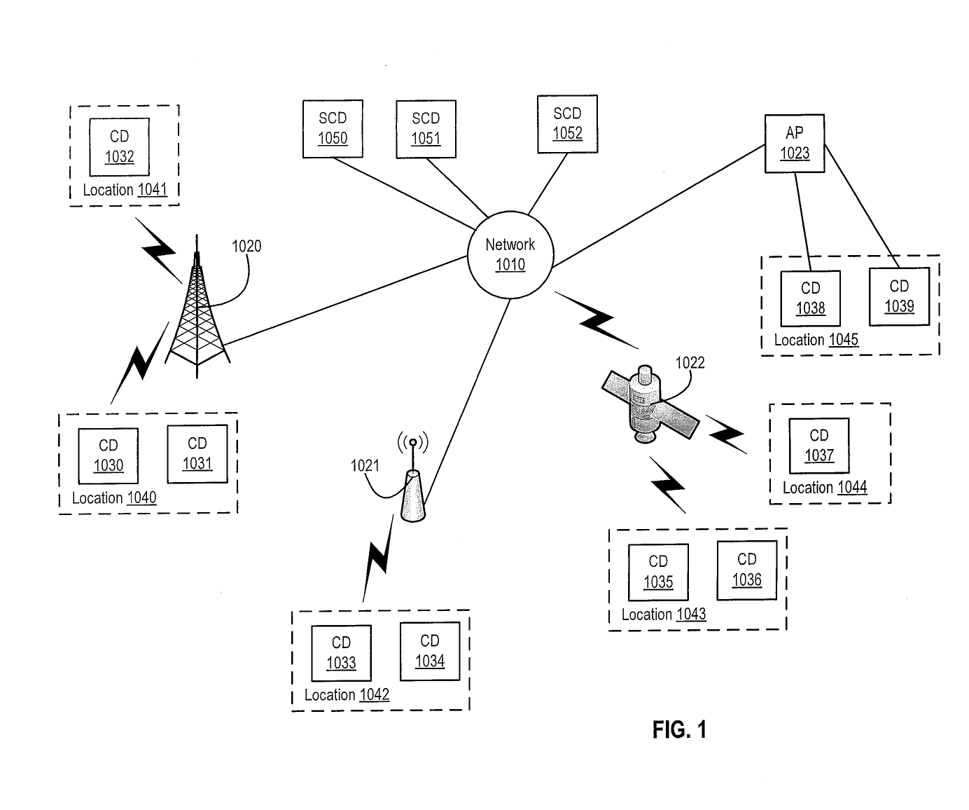

Turning now to FIG. 1, a block diagram of one or more network communications systems is illustrated, according to one or more embodiments. As illustrated, a network 1010 can be coupled to one or more access points (APs) 1020-1023, and each access point (AP) of APs 1020-1023 can be coupled to respective one or more computing devices (CDs) of CDs 1030-1039. In one or more embodiments, CDs 1030-1039 can be coupled to network 1010 through respective APs 1020-1023. In one or more embodiments, an AP, such as one of APs 1020-1023, can be coupled to network 1010 in a wireless and/or wired fashion.

In one or more embodiments, network 1010 can include and/or be coupled to various types of communications networks, such as a wide area network (WAN), a public network such as an Internet, a public switched telephone network (PSTN), and/or a local area network (LAN), among others. In one or more embodiments, one or more of a WAN, a public network such as an Internet, a PSTN, and LAN can include one or more wired networks and/or one or more wireless networks. Thus, one or more of APs 1020-1023 can be coupled to one or more of various networks.

As shown, CDs 1030-1032 can be coupled to AP 1020 in a wireless fashion. In one or more embodiments, AP 1020 can include support for cellular telephone services, and AP 1020 can communicate with CDs 1030-1032 using one or more cellular telephone protocols. For example, AP 1020 can communicate with CDs 1030-1032 using one or more of CDMA (code division multiple access), General Packet Radio Service (GPRS), FDMA (frequency division multiple access), and TDMA (time division multiple access), among others. In one or more embodiments, AP 1020 can include support for a metropolitan area network (MAN). In one example, AP 1020 can communicate with CDs 1030-1032 using one or more MAN protocols. For instance, AP 1020 can communicate with CDs 1030-1032 using WiMAX or IEEE (Institute of Electrical and Electronics Engineers) 802.16. In another instance, AP 1020 can communicate with CDs 1030-1032 using a Long Term Evolution (LTE) protocol. As illustrated, CDs 1030 and 1031 can be at a location 1040, and computing device (CD) 1032 can be at a location 1041.

As shown, CDs 1033 and 1034 can be coupled to AP 1021 in a wireless fashion. In one or more embodiments, AP 1021 can include a wireless access point that can provide one or more of a wireless LAN and/or a wireless personal are network (PAN) services. For example, AP 1021 can communicate with CDs 1033 and 1034 using one or more of WiMax, IEEE 802.16, wireless Ethernet (IEEE 802.11), Bluetooth (IEEE 802.15), IEEE 802.15.4, 6LoWPAN, ultra wide band, and infrared communication technologies, among others. As illustrated, CDs 1032 and 1033 can be at a location 1042.

As shown, CDs 1035-1037 can be coupled to AP 1022 in a wireless fashion. In one or more embodiments, AP 1022 can include a satellite that can communicate with CDs 1035-1037 using one or more satellite telephone protocols and/or one more satellite data transfer protocols. As illustrated, CDs 1035 and 1036 can be at a location 1043, and CD 1037 can be at a location 1044.

As shown, CDs 1038 and 1039 can be coupled to AP 1023 in a wired fashion. In one or more embodiments, AP 1023 can include one or more of an Ethernet port, a router, a DSL (digital subscriber loop) modem, a cable modem, a demarcation for a PSTN, and an Ethernet switch, among others. As illustrated, CDs 1038 and 1039 can be at a location 1045.

As illustrated, one or more server computing devices (SCDs) such as SCDs 1050-1052 can be coupled to network 1010. In one or more embodiments, one or more of SCDs 1050-1052 can communicate with one or more of CDs 1030-1039 via network 1010.

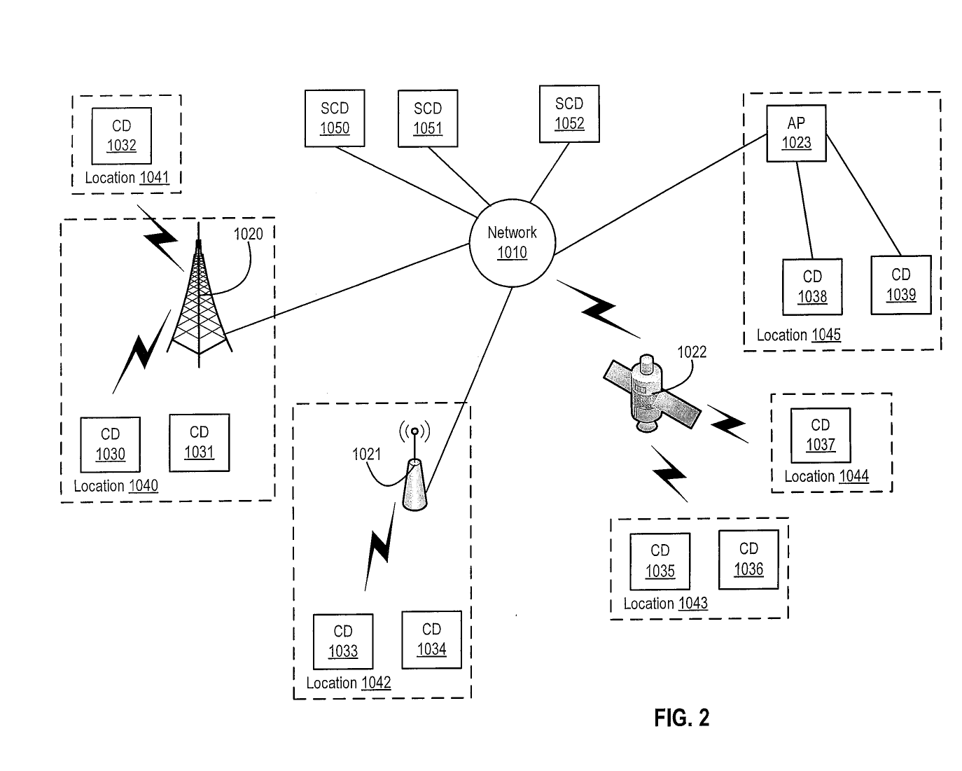

Turning now to FIG. 2, a block diagram of one or more network communications systems is illustrated, according to one or more embodiments. Elements illustrated in FIG. 2 are described with reference to FIG. 1. As illustrated, one or more of APs 1020-1023 can be located at various locations. For example, location 1040 can include AP 1020, location 1042 can include AP 1021, and location 1045 can include AP 1023. In one or more embodiments, locations of one or more APs can be stored in a database. In one or more embodiments, it can be determined which AP is communicating with a CD, and the database can be used to determine a location of the AP which can be used to determine the location of the CD communicating with the AP. For example, it can be determined that AP 1021 is communicating CD 1034, and the database can be used to determine a location of AP 1021 (e.g., location 1042) which can be used to determine the location of CD 1034 communicating with AP 1021. For instance, the location of CD 1034 can be the location of AP 1021 which is location 1042.

In one or more embodiments, locations 1040-1045 can vary in size. In one example, location 1040 can include a geographic area of a some number of thousand feet to some number of miles within a vicinity of AP 1020. In a second example, location 1042 can include a geographic area of some number of tens to hundred(s) of feet within a vicinity of AP 1021. In another example, location 1045 can include a geographic area of an abode, a retail establishment, a bar, a hotel, a dance hall, a pool hall, etc.

In one or more embodiments, a CD can provide its location. In one or more embodiments, each of one or more of CDs 1030-1039 can determine its location and provide its location to another computing device or computer system, such as one of CDs 1030-1039 and SCDs 1050-1052. For example, one or more of CDs 1030-1039 can include a global positioning system (GPS) that can be used to determine a location. In one example, CD 1032 can include a GPS and communicate location 1041 to one or more of CDs 1030, 1032-1039 and SCDs 1050-1052. In another example, CD 1035 can include a GPS and communicate location 1043 to one or more of CDs 1030-1034, 1036-1039 and SCDs 1050-1052.

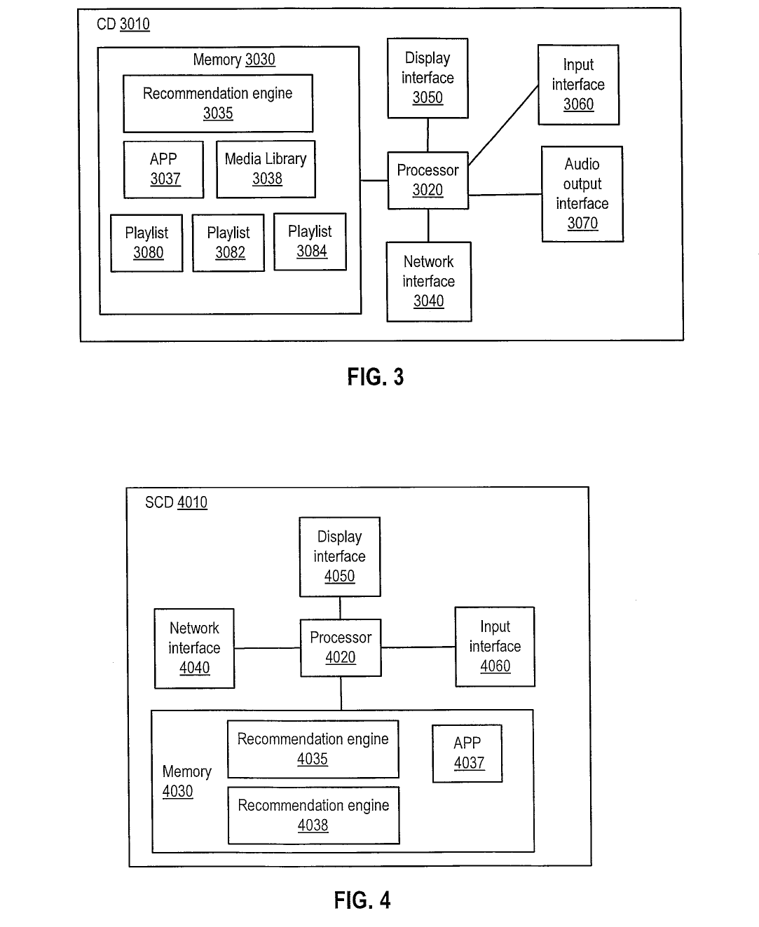

Turning now to FIG. 3, a block diagram of a computing device is illustrated, according to one or more embodiments. As shown, a CD 3010 can include a processor 3020 that can be coupled to a memory 3030. In one or more embodiments, processor can retrieve and execute instructions from memory 3030 to implement one or more methods and/or processes described herein. In one example, memory 3030 can store recommendation engine 3035 and/or application (APP) 3037, and processor can retrieve and execute recommendation engine 3035 and/or APP 3037. In one or more embodiments, each of one or more of recommendation engine 3035 and APP 3037 can be a stand-alone application. In one or more embodiments, each of one or more of recommendation engine 3035 and APP 3037 can be a plug-in application. In one example, each of one or more of recommendation engine 3035 and APP 3037 can be a plug-in application that can plug into another application such as iTunes, a web browser, etc.

In one or more embodiments, memory 3030 can store a media library 3038. For instance, media library 3038 can include one or more pieces of media. In one or more embodiments, one or more pieces of media can be stored in a compressed format, one or more pieces of media can be stored in a non-compressed format, and/or one or more pieces of media can be stored in a lossless format. As illustrated, memory 3030 can store one or more playlists 3080-3084. In one or more embodiments, a playlist can include a group of two or more pieces of media. For example, a playlist can include multiple indices, identifications, and/or pointers to multiple pieces of media stored in media library 3038.

As illustrated, CD 3010 can include a network interface 3040, a display interface 3050, an input interface 3060, and an audio output interface coupled to processor 3020. In one or more embodiments, network interface can include logic, circuitry, and/or a transceiver configured to interface and communicate with one or more of APs 1020-1023. In one or more embodiments, display interface 3050 can interface with a display configured to convey information to a user of CD 3010. In one example, the display can be included in CD 3010. In another example, the display can be external to CD 3010. In one or more embodiments, input interface 3060 can receive user input from a user of CD 3010. In one example, input interface 3060 can interface with a keyboard. In a second example, input interface 3060 can interface with a pointing device (e.g., a mouse, track pad, track ball, etc.). In a third example, input interface 3060 can interface with a microphone (e.g., to receive voice input commands). In another example, input interface 3060 can interface with a touch screen (e.g., resistive sense, capacitive sense, etc.). In one or more embodiments, one or more of the keyboard, the pointing device, the microphone, and the touch interface can be included in CD 3010 or can be external to CD 3010.

In one or more embodiments, audio output interface 3070 can convey audio signals and/or data to an audio output device. In one example, the audio output device can include logic and/or circuitry that can be used in outputting sound signals. For instance, the logic and/or circuitry can include one or more digital-to-analog converters. In another example, the audio output device can include one or more speakers. In one or more embodiments, the one or more speakers can be included in CD 3010 or can be external to CD 3010.

In one or more embodiments, CD 3010 can take various forms, including a mobile wireless telephone, a personal digital assistant (PDA), a laptop, a notebook, a netbook, a network appliance, an Internet appliance, a wearable computing device, a mobile multimedia device, an embedded computer system, a television system, a workstation, a personal computer system (e.g., a desktop computer system), and/or other device.

In one or more embodiments, terms such as “computing device”, “computer”, and/or “computer system” can be broadly defined to encompass any device including a processor that executes instructions from a memory. In one or more embodiments, one or more of CDs 1030-1039 can include one or more elements and/or one or more functionalities described with reference to CD 3010.

Turning now to FIG. 4, a block diagram of a server computing device is illustrated, according to one or more embodiments. As shown, a SCD 4010 can include a processor 4020 that can be coupled to a memory 4030. In one or more embodiments, processor can retrieve and execute instructions from memory 4030 to implement one or more methods and/or processes described herein. As illustrated, SCD 4010 can include a network interface 4040, a display interface 4050, and an input interface 4060 coupled to processor 4020. In one or more embodiments, network interface can include logic, circuitry, and/or a transceiver configured to interface and communicate with network 1010. In one or more embodiments, display interface 4050 can interface with a display configured to convey information to a user of SCD 4010. For example, the display can be included in SCD 4010 or be external to SCD 4010. In one or more embodiments, input interface 4060 can receive user input from a user of SCD 4010. For example, the user can be at a console interface of SCD 4010. In one example, input interface 3060 can interface with a keyboard. In a second example, input interface 3060 can interface with a pointing device (e.g., a mouse, track pad, track ball, etc.). In one or more embodiments, one or more of SCDs 1050-1052 can include one or more elements and/or one or more functionalities described with reference to SCD 4010.

As illustrated, memory 4030 can include a recommendation engine 4035 that can include instructions executable by processor 4020 to implement a recommendation engine. In one or more embodiments, a recommendation engine (which can also be referred to as an affinity engine or a recommendation system) can be used to determine one or more recommendations of one or more pieces of media associated with one or more selection criteria. For example, the recommendation engine can use input from one or more users and/or one or more media libraries of the one or more users to generate one or more recommendations of one or more pieces of media.

In one or more embodiments, each piece of media (e.g., played, playing, in a media library, etc.) can be associated with one or more quantifiable attributes. In one example, the one or more attributes can include one or more genres. For instance, the one or more genres can include one or more of country, rock, classical, swing, big band, 80s, 70s, 60s, hip hop, rap, top 40, and pop, among others. In a second example, the one or more attributes can include one or more numbers that indicate how many times specific pieces of media are played. In a third example, the one or more attributes can include one or more preferences for one or more of musicians, books, movies, actors, directors, studios, genres, song ratings, musician ratings, genre ratings, and user specified preferences (e.g., specifying a favorite musician, a favorite book, a favorite movie, a favorite actor, a favorite director, a favorite studio, a favorite song, a top-10 favorite musicians, a top-10 favorite songs, etc.), and a grouping of pieces of media (e.g., a playlist), among others. In another example, the one or more attributes can include one or more dislikes. For instance, the one or more dislikes can include one or more genres, musicians, and pieces of media, among others. In one or more embodiments, the recommendation engine can use multiple pieces of media played over a period of time by a computing device to generate one or more recommendations.

As illustrated, memory 4030 can include recommendation engine 4038 and/or APP 4037, according to one or more embodiments. For example, SCD 4010 can store and/or distribute recommendation engine 4038 and/or APP 4037 via network interface 4040. For instance, SCD 4010 can store and/or distribute recommendation engine 4038 and/or APP 4037 to one or more of CDs 1030-1039 and CD 3010. In one example, SCD 4010 can transmit one or more of recommendation engine 4038 and APP 4037 to CD 3010 via network interface 4040. In another example, CD 3010 can receive one or more of recommendation engine 4038 and APP 4037 via network interface 3040 and can store one or more of recommendation engine 4038 and APP 4037 as recommendation engine 3035 and APP 3037, respectively.

In one or more embodiments, terms such as “memory medium” and/or “computer readable medium” can include one or more types of memory or storage, a random access memory or computer system memory such as DRAM, SRAM, and/or RAM, among others, a non-volatile memory such as NVRAM, EPROM, EEPROM, flash memory, a magnetic media, e.g., a hard drive, and/or optical storage, including an installation medium, e.g., a CD-ROM, DVD-ROM, or floppy disks, among others. In one or more embodiments, a memory medium can include other types of memory as well, or combinations thereof. In one or more embodiments, a memory medium can be and/or include an article of manufacture and/or a software product. For example, a memory medium can store instructions executable by a processor or computer system.

In one or more embodiments, a memory medium can be located in a first computer in which the instructions are executed. In one or more embodiments, a memory medium can be located in a second different computer and/or hardware memory device that connects to a first computer over a network. For example, the second computer provides program instructions to the first computer for execution by the first computer.

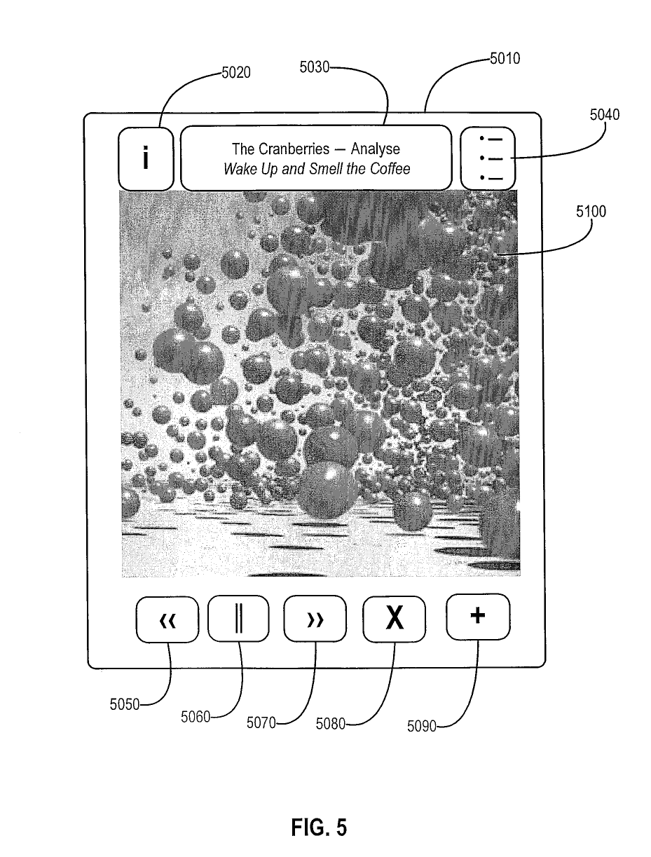

Turning now to FIG. 5, an exemplary diagram of a media player application is illustrated, according to one or more embodiments. As illustrated, a display area or window 5010 can include one or more elements 5020-5100. In one or more embodiments, APP 3037 can be executed by processor 3020, and CD 1030 can display window 5010 via display interface 3050. In one or more embodiments, one or more of elements 5020-5090 can be icons and/or buttons that can be selected and/or actuated by a user. As shown, element 5030 can display information regarding a piece of media that is currently playing. For example, element 5030 can display one or more of: an artist identifier (e.g., artist name), The Cranberries; a song title, “Analyse”; and an album title, Wake Up and Smell the Coffee. Element 5020 can be selected by the user to report (e.g., visually and/or audibly) further information associated with the piece of media currently playing. Element 5060 can be selected by the user to pause the piece of media currently playing. Element 5080 can be selected by the user to indicate a negative rating regarding the piece of media currently playing. Element 5090 can be selected by the user to indicate a positive rating regarding the piece of media currently playing. Element 5100 can include one or more pictures associated with a piece of media that is currently playing. In one example, album art can be displayed via element 5100. In another example, one or more videos and/or graphics (e.g., moving and/or motion picture(s)) can be displayed via element 5100. In one or more embodiments, the piece of media that is currently playing may have been selected by the user. In one example, the user may have selected the piece of media from media library 3038. In another example, the user may have selected the piece of media from a server. For instance, the piece of media that is currently playing can be streaming from the server.

In one or more embodiments, element 5040 can be selected by the user to display a playlist. For example, element 5040 can be selected by the user to display a playlist that is associated with the piece of media that is currently playing. For instance, the playlist can include the piece of media that is currently playing. In one or more embodiments, element 5050 and/or element 5070 can be selected by the user to, respectively, go to a previous and/or a subsequent piece of media in a playlist that is associated with the piece of media that is currently playing. For example, the playlist can include the piece of media that is currently playing.

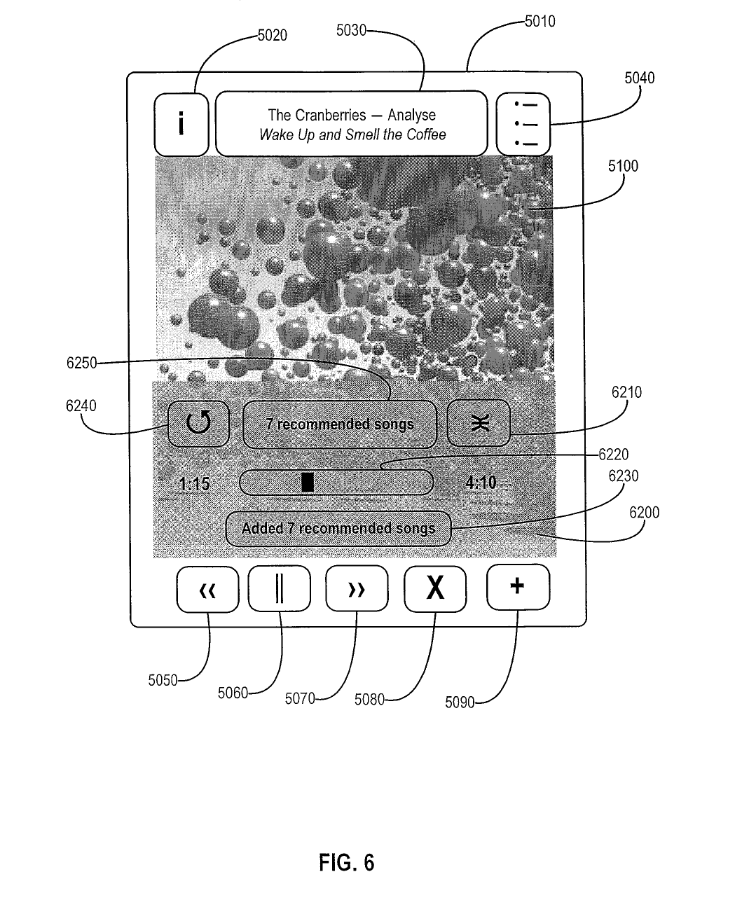

Turning now to FIG. 6, an exemplary diagram of a media player application is illustrated, according to one or more embodiments. As illustrated, display area or window 5010 can include one or more elements 6210-6250, among others. In one or more embodiments, one or more of elements 6210-6250 can be icons and/or buttons that can be selected and/or actuated by a user. In one or more embodiments, element 6240 can be selected by the user to repeat and/or loop the piece of media that is currently playing. In one or more embodiments, element 6210 can be selected by the user to randomize a playlist associated with the piece of media that is currently playing. In one or more embodiments, element 6220 can indicate, in a graphical fashion, a position and/or progress of the piece of media that is currently playing. For example, element 6220 can graphically indicate that the position and/or progress of the piece of media that is currently playing is “1:15” of “4:15”, where “1:15” is one minute and fifteen seconds. In one example, a time index can be expressed by “hours:minutes:second”. In another example, a time index can be expressed by “hours:minutes:second:frame”, where frame can include numbers from one to thirty. In one or more embodiments, other time indexes and/or time indexing systems can be applied and/or used.

As illustrated, element 6250 can indicate that seven pieces of media have been recommended to the user. In one or more embodiments, the seven recommended pieces of media can be based on a positive indication, by the user, of the piece of media that is currently playing. In one example, the user can actively and/or explicitly provide user input to indicate the positive indication by selecting element 5090. In one or more embodiments, a positive indication, by the user, of the piece of media that is currently playing can be determined in a passive fashion. In one example, CD 1030 can play the piece of media that is currently playing for a period of time without the user providing a negative indication of the piece of media that is currently playing. For instance, the piece of media that is currently playing can be played for at least a number of seconds (e.g., fifteen seconds, twenty second, thirty seconds, etc.) without the user providing a negative indication of the piece of media that is currently playing, and this can be used to determine a positive indication of the piece of media that is currently playing, in a passive fashion. As illustrated, element 6230 can indicate that the seven recommended pieces of media were added to a playlist of media associated with the piece of media that is currently playing. As shown, element 6200 can provide a background for elements 6210-6250.

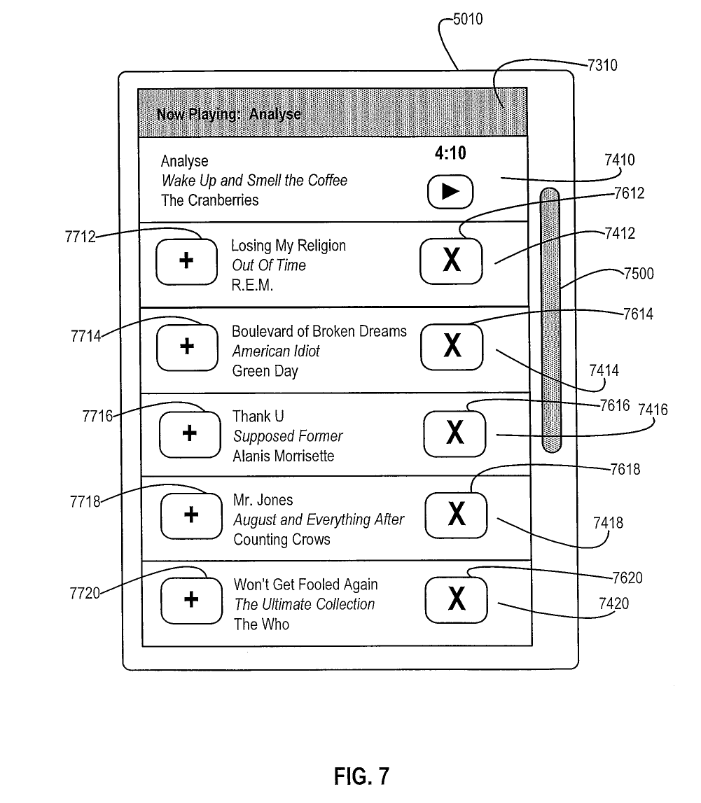

Turning now to FIG. 7, an exemplary diagram of a media player application is illustrated, according to one or more embodiments. As illustrated, display area or window 5010 can include one or more elements 7310-7720. In one or more embodiments, one or more of elements 7410-7720 can be icons and/or buttons that can be selected and/or actuated by a user. As illustrated, elements 7410-7420 can indicate information associated with and/or identifying one or more pieces of media of a playlist and/or one or more recommend pieces of media. As shown, element 7310 can indicate a piece of media that is currently playing. For example, element 7310 can indicate that the song “Analyse” is currently playing. In one or more embodiments, the piece of media associated with element 7410 can be included in a playlist of media. In one or more embodiments, recommended pieces of media associated with elements 7412-7420 can be included in a recommend list of media. In one or more embodiments, the recommended list of media can be based on the piece of media that is currently playing. In one or more embodiments, the recommended list of media can be based on input from one or more users. In one example, the input from the one or more users can include multiple positive and/or negative ratings of one or more pieces of media, describer further below. In another example, the input from the one or more users can include multiple quantifiable ratings of one or more pieces of media. For instance, multiple quantifiable ratings of one or more pieces of media can include a number of stars (e.g., on a five-star basis) of one or more pieces of media. In one or more embodiments, the recommended list of media can be based on input, from the user of CD 1050, that can include multiple ratings of one or more pieces of media via multiple ratings. For example, the multiple rating can be determined from iterating receiving user input indicating a rating for each piece of media of multiple pieces of media.

As illustrated, display area or window 5010 can include element 7500 which can be used as a scrollbar. For example, scrollbar 7500 can be used to scroll through and/or display, via window 5010, multiple elements associated with multiple pieces of media. In one or more embodiments, elements 7612-7620 can be used to receive a negative indication of recommended pieces of media 7412-7420, respectively. In one or more embodiments, elements 7612-7620 can be used to receive a positive indication of recommended pieces of media 7412-7420, respectively.

In one or more embodiments, a list of recommended pieces of media displayed by window 5010 can include one or more recommended pieces of media from media library 3038. For example, the one or more recommended pieces of media from media library 3038 may be considered to be stored locally on CD 1030. In one or more embodiments, the list of recommended pieces of media displayed by window 5010 can include one or more recommended pieces of media from one or more servers (e.g., one or more of SCDs 1050-1052). For example, the one or more recommended pieces of media from the one or more servers can be streamed and/or downloaded to CD 1030. In one or more embodiments, the recommended playlist displayed by window 5010 can include one or more recommended pieces of media from one or more servers and one or more recommended pieces of media from media library 3038. For example, the list of recommended pieces of media displayed by window 5010 can include one or more recommended pieces of media that are interleaved with one or more recommended pieces of media from media library 3038 and one or more recommended pieces of media from the one or more servers.

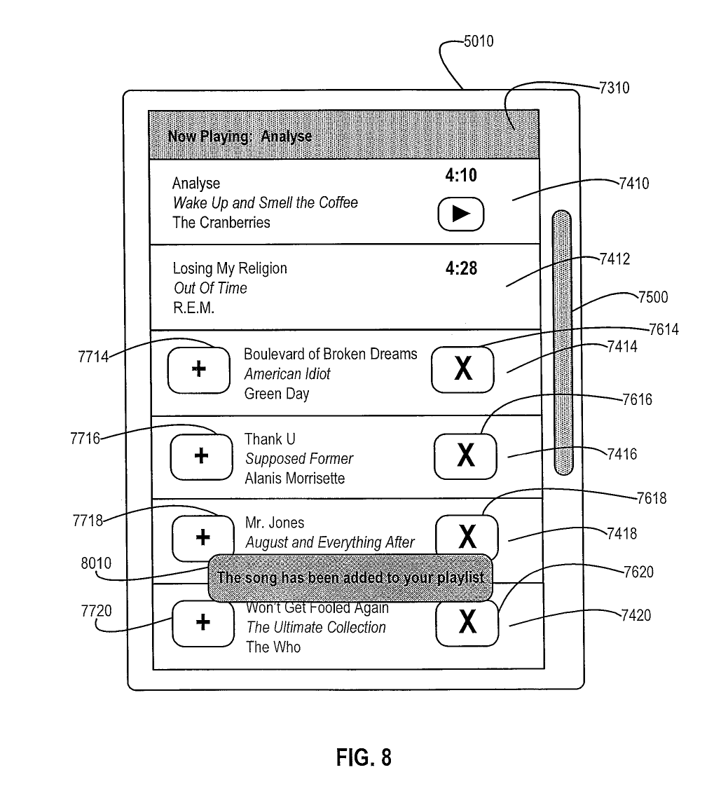

Turning now to FIG. 8, an exemplary diagram of a media player application is illustrated, according to one or more embodiments. As illustrated, display area or window 5010 can include element 8010, among others. In one or more embodiments, element 8010 can indicate that a piece of media has been added to a playlist. For example, CD 1030 may have received user input of a positive indication of a piece of media associated with element 7412. For instance, the user input can include CD 1030 receiving a selection and/or actuation of element 7712 (of FIG. 7), which can be used to determine a positive indication of the piece of media associated with element 7412. As illustrated, elements 7712 and 7410 (of FIG. 7) may not be displayed by window 5010, after the piece of media associated with element 7412 has been added to the playlist, according to one or more embodiments. In one example, the playlist can include pieces of media associated with elements 7410 and 7412, after the piece of media associated with element 7412 has been added to the playlist.

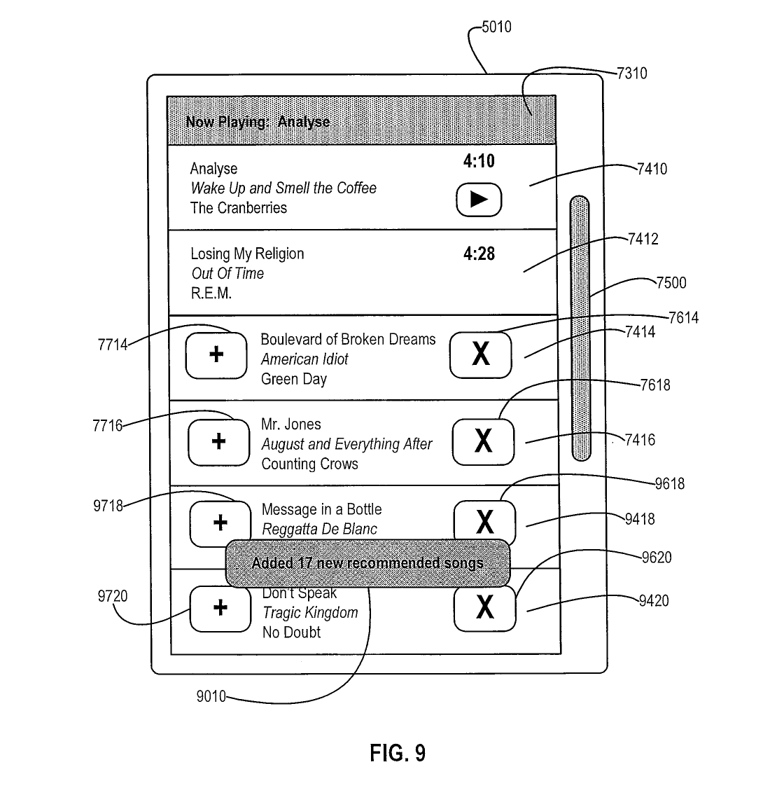

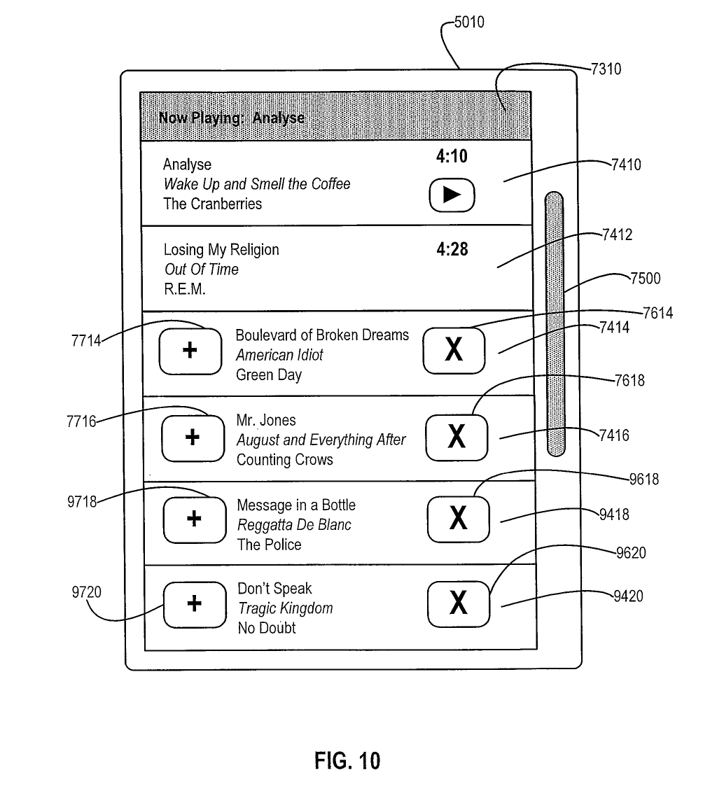

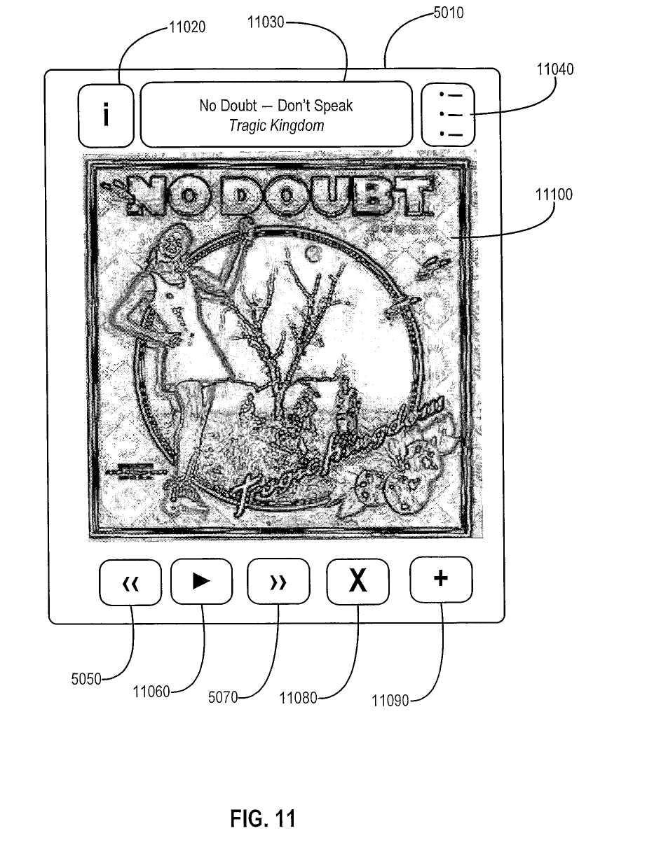

Turning now to FIGS. 9 and 10, exemplary diagrams of a media player application are illustrated, according to one or more embodiments. As illustrated, display area or window 5010 can include one or more elements 9010-9720, among others. In one or more embodiments, one or more of elements 9010-9720 can be icons and/or buttons that can be selected and/or actuated by a user. As illustrated, elements 9418 and 9420 can indicate information associated with and/or identifying recommended pieces of media.

In one or more embodiments, one or more pieces of recommended media can be added to the recommended media list based on one or more added pieces of media to the playlist. As shown, recommended pieces of media associated with elements 9418 and 9420 can be added to the recommended media list. For instance, the pieces of media associated with elements 9418 and 9420 can be added to the recommended media list based on an addition, of the piece of media associated with element 7412, to the playlist. In one or more embodiments, elements 9618 and 9620 can be used to receive a negative indication of recommended pieces of media 9420 and 9422, respectively. In one or more embodiments, elements 9720 and 9722 can be used to receive a positive indication of recommended pieces of media 9420 and 9422, respectively. As illustrated, element 9010 can indicate that seventeen new recommended pieces of media have been added to the recommended media list. In one or more embodiments, element 9010 can be removed from window 5010, as illustrated in FIG. 10, after an amount of time transpiring.

In one or more embodiments, one or more pieces of recommended media can be removed from the recommended media list based on one or more added or removed pieces of media to the playlist. As shown, recommended pieces of media associated with elements 7416 and 7420 (of FIG. 8) can be removed from the recommended media list. For instance, the pieces of media associated with elements 7416 and 7420 (of FIG. 8) can be removed from the recommended media list based on an addition, of the piece of media associated with element 7412, to the playlist.

In one or more embodiments, CD 1030 can receive user input to indicate that more information regarding a piece of recommended media is desired by the user. In one example, CD 1030 can receive the user input by the user selecting element 9420.

Turning now to FIG. 11, an exemplary diagram of a media player application is illustrated, according to one or more embodiments. As illustrated, display area or window 5010 can include elements 11020-11100, among others. In one or more embodiments, one or more of elements 11020-11100 can be icons and/or buttons that can be selected and/or actuated by a user.

As illustrated, element 11020 can be selected by the user to report (e.g., visually and/or audibly) further information associated with the selected piece of media. Element 11030 can indicate information associated with and/or identifying a selected piece of media (e.g., the recommended piece of media associated with element 9420 of FIG. 10). For example, element 11030 can display one or more of: an artist identifier (e.g., artist name), No Doubt; a song title, “Don't Speak”; and an album title, Tragic Kingdom. Element 11040 can be selected by the user to return to the playlist and/or the recommended media list. For example, element 11040 can be selected by the user to return to the list illustrated in FIG. 10. Element 11060 can be selected by the user to play the selected piece of media. Element 11080 can be selected by the user to indicate a negative rating regarding the selected piece of media. Element 11090 can be selected by the user to indicate a positive rating regarding the selected piece of media. Element 11100 can include one or more pictures associated with the selected piece of media. In one example, album art can be displayed via element 11100. In another example, one or more videos and/or graphics (e.g., moving and/or motion picture(s)) can be displayed via element 11100.

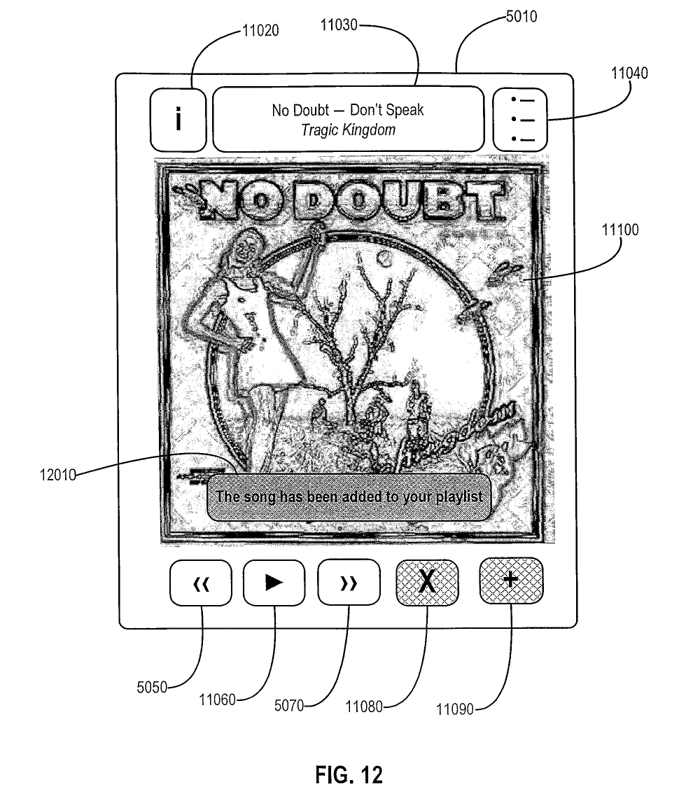

Turning now to FIG. 12, an exemplary diagram of a media player application is illustrated, according to one or more embodiments. As illustrated, display area or window 5010 can include element 12010, among others. In one or more embodiments, element 12010 can indicate that the selected piece of media has been added to the playlist. For example, the selected piece of media can be added to the playlist by receiving user input via element 11090 (of FIG. 11). In one or more embodiments, elements 11080 and 11090 can be shaded to indicate that elements 11080 and 11090 are no longer available to accept user input, since the selected piece of media has been added to the playlist. In one or more embodiments, elements 11080 and 11090 can be removed from window 5010, after the selected piece of media has been added to the playlist.

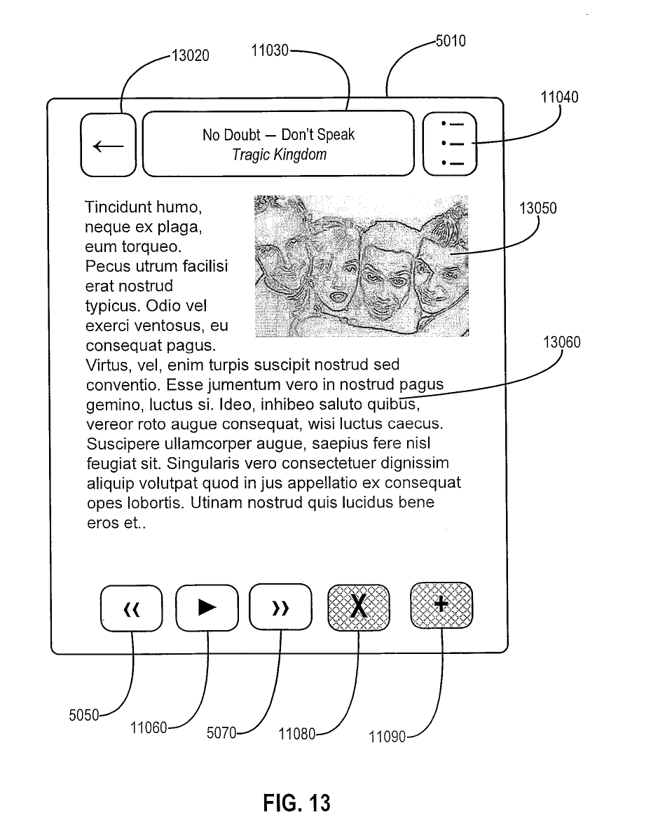

Turning now to FIG. 13, an exemplary diagram of a media player application is illustrated, according to one or more embodiments. As illustrated, display area or window 5010 can include elements 13020-13060, among others. In one or more embodiments, the information illustrated in FIG. 13 can be displayed in response to user input selecting element 11020 (of FIG. 12). As illustrated, element 13020 can be selected, by the user, to return to the information illustrated in FIG. 12, according to one or more embodiments. As shown, element 13050 can display a graphic associated with the selected piece of media. For example, element 13050 can display a picture of the artist or group No Doubt. In one or more embodiments, element 13060 can display text information associated with the selected piece of media. For example, the text information associated with the selected piece of media can include one or more of liner notes, concert dates, concert locations, lyrics, album release information, record signing information, fan club information, and biographical information, among others. For illustrative and/or exemplary purposes, “greeking” (e.g., nonsensical filler text) has been used where textual information associated with the selected piece of media may be placed.

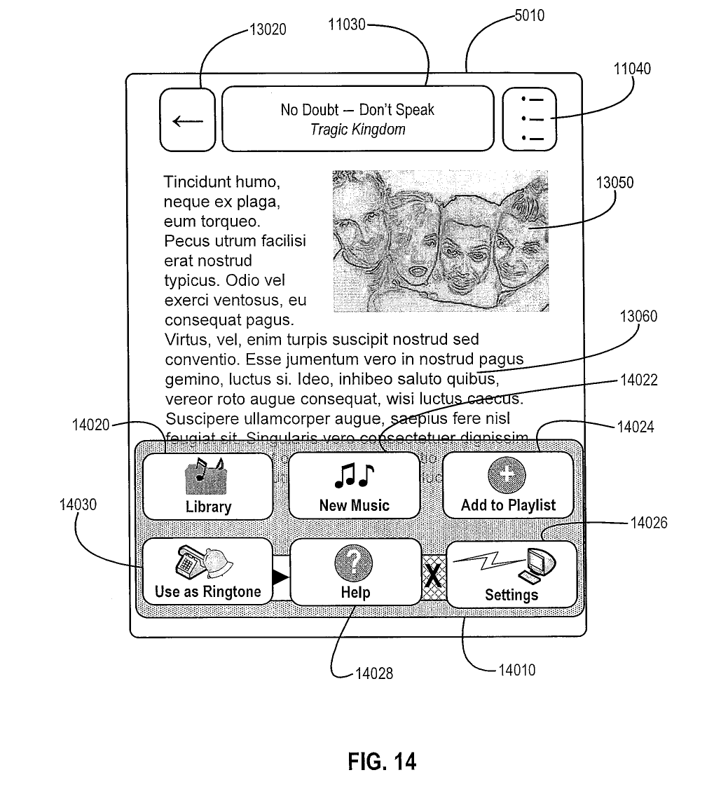

Turning now to FIG. 14, an exemplary diagram of a media player application is illustrated, according to one or more embodiments. As illustrated, display area or window 5010 can include elements 14010-14030, among others. In one or more embodiments, a menu 14010 can include menu elements 14020-14030 that can be icons and/or buttons that can be selected and/or actuated by a user.

In one or more embodiments, menu item 14020 can be selected to display one or more pieces of media from a media library (e.g., media library 3038); menu item 14022 can be selected to display a list of new recommended music (e.g., music that is not included in library 3038); menu item 14024 can be selected to add a piece of media to a playlist; menu item 14026 can be selected to display and/or access one or more setting of CD 1030; menu item 14028 can be selected to obtain help and/or assistance; and/or menu item 14030 can be selected to create and/or use a piece of media or a portion of a piece of media as a ringtone. In one example, menu item 14024 can be selected to stream and/or download new recommended music from one or more servers (e.g., one or more of SCDs 1050-1052). In one instance, the new recommended music from one or more servers can be streamed from a subscription service (e.g., for free, for a fee, etc.). In another instance, the new recommended music from one or more servers can be downloaded and stored in media library 3038 (e.g., for free, for a fee, etc.).

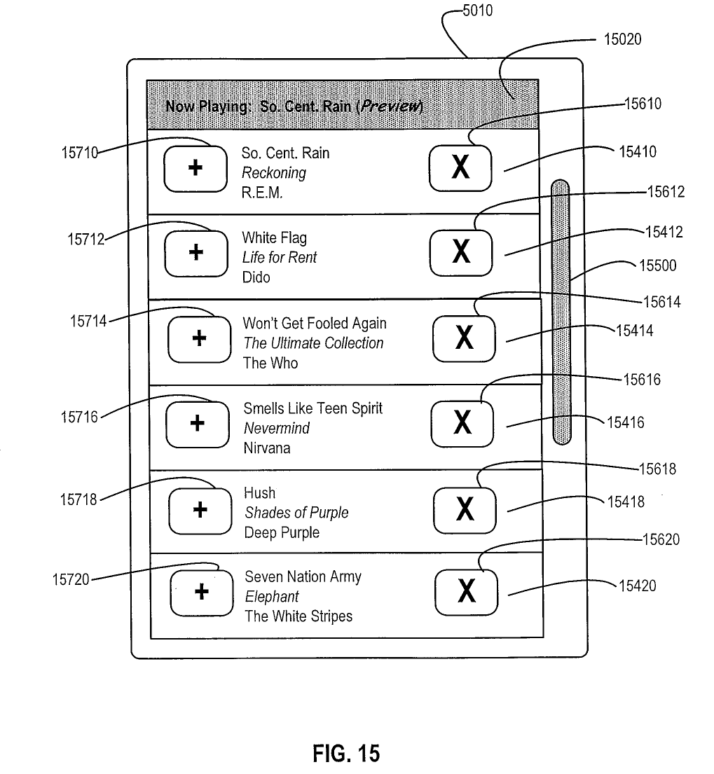

Turning now to FIG. 15, an exemplary diagram of a media player application is illustrated, according to one or more embodiments. As illustrated, display area or window 5010 can include one or more elements 15020-15720. In one or more embodiments, one or more of elements 15410-15720 can be icons and/or buttons that can be selected and/or actuated by a user. In one or more embodiments, this window illustrated in FIG. 15 can be displayed by APP 3037 in response to user input selecting element 14022 (of FIG. 14). For example, the user can select element 14022 to preview one or more recommended new pieces of media (e.g., one or more recommended pieces of media that are not included in media library 3038). In one or more embodiments, the one or more recommended new pieces of media from one or more servers (e.g., one or more of SCDs 1050-1052).

As illustrated, elements 15410-15420 can indicate information associated with and/or identifying one or more recommended new pieces of media of a playlist. As shown, element 15020 can indicate a recommended new piece of media that is currently playing. In one or more embodiments, a portion of the recommended new piece of media can be played. For example, the portion of the recommended new piece of media can be a preview of the recommended new piece of media. As illustrated, element 15020 can indicate that a preview of the song “So. Cent. Rain” is currently playing, for example. In one or more embodiments, the piece of media associated with element 15410 can be included in a list of recommended new pieces of media. In one or more embodiments, recommended new pieces of media associated with elements 15412-15420 can be included in a list of recommended new pieces of media.

As shown, display area or window 5010 can include element 15500 which can be used as a scrollbar. For example, scrollbar 15500 can be used to scroll through and/or display, via window 5010, multiple elements associated with multiple recommended new pieces of media. In one or more embodiments, elements 15610-15620 can be used to receive a negative indication of recommended new pieces of media 15410-15420, respectively. For example, APP 3037 can receive user input via element 15612 to determine a negative indication of a recommended new piece of media associated with element 15412. For instance, element 15412 can be removed from the list of recommended new piece of media. In one or more embodiments, a recommendation engine (e.g., recommendation engine 4035, recommendation engine 3035, etc.) can modify the list of recommended new piece of media based on the negative indication of the recommended new piece of media associated with element 15412.

In one or more embodiments, a list of recommended new pieces of media can be determined by a recommendation engine. In one example, the recommendation engine can be executed on a server (e.g., recommendation engine 4035 executed on a server of SCDs 1050-1052). In another example, the recommendation engine can be executed on a computing device (e.g., recommendation engine 3035 executed on CD 1030). In one or more embodiments, the recommendation engine can determine the list of recommended new pieces of media based on a piece of media that is currently playing (e.g., the piece of media associated with element 7410); a piece of media that has received a positive indication (e.g., the piece of media associated with element 7412); a piece of media that has received a negative indication; and/or one or more playlists (e.g., one or more of playlists 3080-3084). In one or more embodiments, the recommendation engine can determine the list of recommended new pieces of media based on input from one or more users. In one example, the input from the one or more users can include multiple positive and/or negative ratings of one or more pieces of media. In another example, the input from the one or more users can include multiple quantifiable ratings of one or more pieces of media. For instance, multiple quantifiable ratings of one or more pieces of media can include a number of stars (e.g., on a five-star basis) of one or more pieces of media. In one or more embodiments, the recommendation engine can determine the list of recommended new pieces of media based on input, from the user of CD 1050, that can include multiple ratings of one or more pieces of media via multiple ratings. For example, the multiple rating can be determined from iterating receiving user input indicating a rating for each piece of media of multiple pieces of media.

In one or more embodiments, elements 15710-15720 can be used to receive a positive indication of recommended new pieces of media 15410-15420, respectively. For example, APP 3037 can receive user input via element 15710 to determine a positive indication of a recommended new piece of media associated with element 15410. For instance, element 15410 can be added to a playlist (e.g., a playlist of playlists 3080-3082). In one or more embodiments, a recommendation engine (e.g., recommendation engine 4035, recommendation engine 3035, etc.) can modify the list of recommended new piece of media based on the positive indication of the recommended new piece of media associated with element 15410.

In one or more embodiments, receiving a positive indication of a recommended new piece of media can initiate a purchase process. In one example, the purchase process can include adding the recommended new piece of media, associated with the positive indication, to a shopping cart and/or list of possible items for purchase by the user of CD 1030. In a second example, the purchase process can include automatically downloading the recommended new piece of media, associated with the positive indication, to media library 3038 in exchange for compensation. In one instance, the compensation can include a fee for downloading the recommended new piece of media, associated with the positive indication. In a second instance, the compensation can be associated with a subscription service, such as a subscription service that allows for multiple downloads over a period of time (e.g., a day, a week, a month, a year, etc.).

In one or more embodiments, compensation information associated with the user of CD 1030 can be stored and/or used by one or more servers (e.g., one or more servers of SCDs 1050-1052). For example, the compensation information can include account information. For instance, the account information can include one or more of credit card information, bank account information, prepaid card information, and gift card information, among others. In one example, a fee can be applied to one or more of a credit card account, a prepaid card account, and a bank account, among others. In a second example, a count can be decremented from one or more of a prepaid card amount and a gift card amount (e.g., five downloads, ten downloads, twenty downloads, etc.).

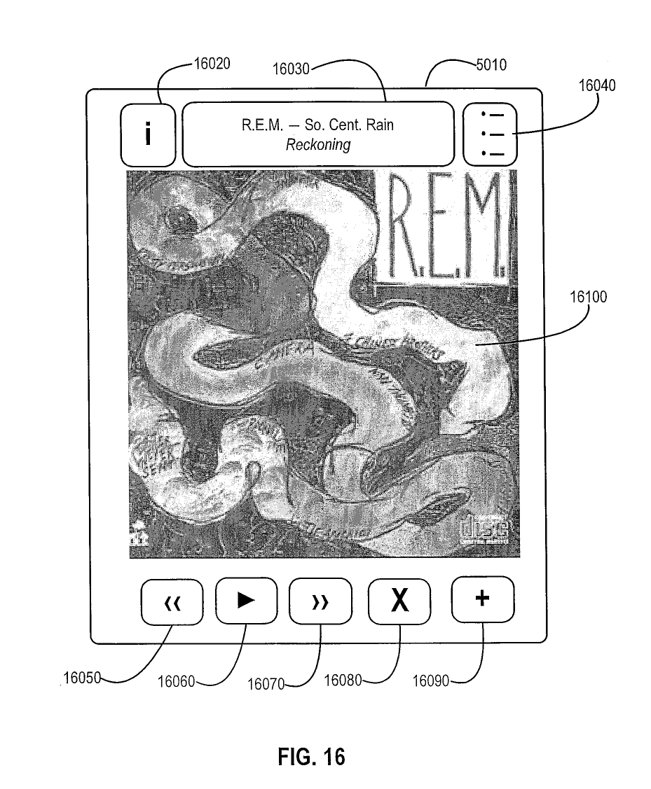

Turning now to FIG. 16, an exemplary diagram of a media player application is illustrated, according to one or more embodiments. As illustrated, display area or window 5010 can include elements 16020-16100, among others. In one or more embodiments, one or more of elements 16020-16100 can be icons and/or buttons that can be selected and/or actuated by a user. In one or more embodiments, the window illustrated in FIG. 16 can be displayed after a user selects element 15410 (of FIG. 15).

In one or more embodiments, element 16020 can be selected by the user to report (e.g., visually and/or audibly) further information associated with the selected recommended new piece of media. Element 16030 can indicate information associated with and/or identifying a selected piece of media (e.g., the recommended new piece of media associated with element 15410 of FIG. 15). For example, element 16030 can display one or more of: an artist identifier (e.g., artist name), R.E.M.; a song title, “So. Cent. Rain”; and an album title, Reckoning. Element 16040 can be selected by the user to return to the list of recommended new pieces of media. For example, element 16040 can be selected by the user to return to the list illustrated in FIG. 15. Element 16060 can be selected by the user to play or preview the selected recommended new piece of media. Element 16080 can be selected by the user to indicate a negative rating regarding the selected recommended new piece of media.

Element 16090 can be selected by the user to indicate a positive rating regarding the selected recommended new piece of media. In one or more embodiments, user input selecting element 16090 can indicate that the selected recommended new piece of media can be downloaded from a server (e.g., a server of SCDs 1050-1053) to media library 3038. For example, the selected recommended new piece of media can be downloaded to media library 3038 for a fee or for free. In one instance, the selected recommended new piece of media can be downloaded to media library 3038 as part of a fee-based subscription service. In another instance, the selected recommended new piece of media can be downloaded to media library 3038 on a per piece of media basis (e.g., via a per piece of media basis from an online media retailer such as iTunes, AmazonMP3, etc.). In one or more embodiments, element 16100 can include one or more pictures associated with the selected piece of media. In one example, album art can be displayed via element 16100. In another example, one or more videos and/or graphics (e.g., moving and/or motion picture(s)) can be displayed via element 16100.

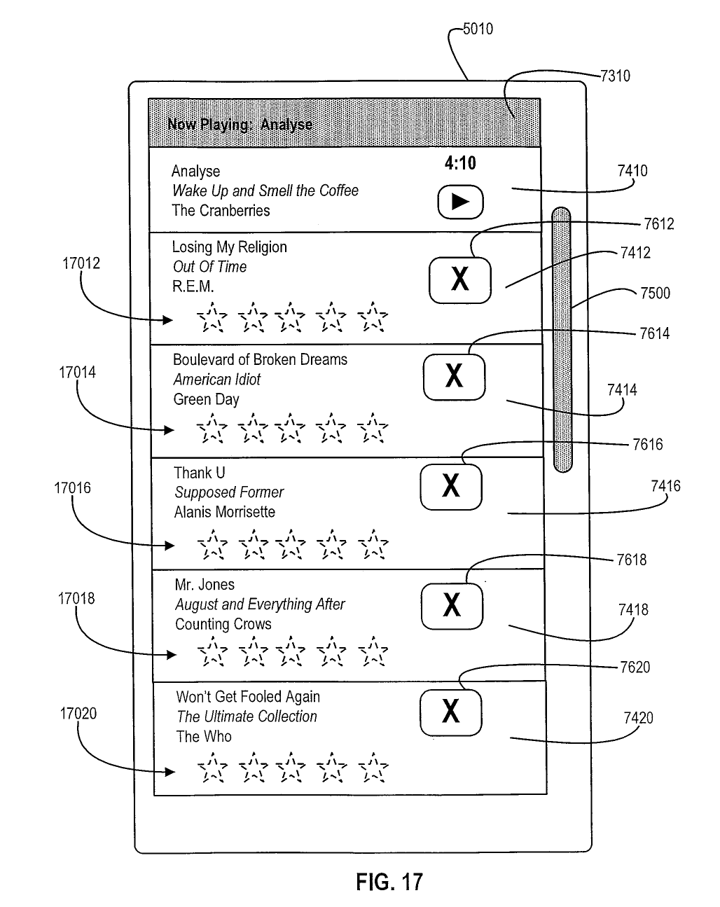

Turning now to FIG. 17, an exemplary diagram of a media player application is illustrated, according to one or more embodiments. As illustrated, display area or window 5010 can include rating elements (e.g., stars) 17012-17020, among other elements. In one or more embodiments, FIG. 17 can be described with reference to FIG. 7 and rating elements 17012-17020 can be used instead of elements 7712-7720. In one or more embodiments, one or more of elements rating elements 17012-17020 can be icons and/or buttons that can be selected and/or actuated by a user. In one or more embodiments, one or more of elements rating elements 17012-17020 can be used to rate one or more pieces of media that are included in media library 3038, and/or one or more of elements rating elements 17012-17020 can be used to rate one or more pieces of media that are not included in media library 3038.

In one or more embodiments, rating elements 17012-17020 can used to receive user input regarding user ratings of respective pieces of media associated with elements 7412-7420. In one example, user input can be received on a five-star basis, where the user input can indicate a rating of zero to five stars. In one instance, one or more portions of stars can be indicated by the user input (e.g., one-third of a star, one-half of a star, two-thirds of a star, etc.). In another instance, whole numbers and/or integral numbers of stars can be indicated by the user input (e.g., one star, two stars, three stars, four stars, five stars, etc.). In one or more embodiments, a threshold indication amount can be used to determine whether or not to add a piece of media to a media library and/or a playlist. For example, if the threshold indication amount is indicated and/or met via user input, then a piece of media can be added to a media library and/or a playlist. In one or more embodiments, receiving a rating that meets or exceeds the threshold indication amount of a recommended new piece of media can initiate a purchase process.

In one example, the threshold indication amount can be two and one-half stars. In one instance, if user input indicates a rating of two and one-half stars or more stars for a piece of media, then the piece of media can be added to a media library and/or a playlist. In a second instance, if user input does not indicate a rating of at least two and one-half stars for a piece of media, then the piece of media is not added to a media library and/or a playlist. In another example, the threshold indication amount can be three stars. In one instance, if user input indicates a rating of three or more stars for a piece of media, then the piece of media can be added to a media library and/or a playlist. In a second instance, if user input does not indicate a rating of at least three stars for a piece of media, then the piece of media is not added to a media library and/or a playlist.

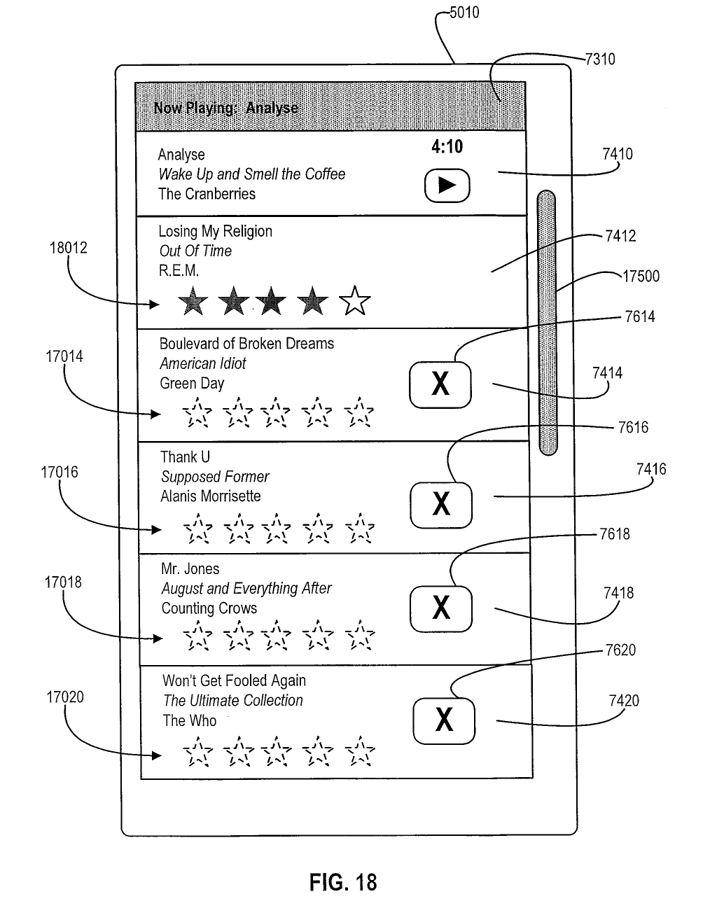

Turning now to FIG. 18, an exemplary diagram of a media player application is illustrated, according to one or more embodiments. As illustrated, display area or window 5010 can include selected rating elements (e.g., stars) 18012, among other elements. In one or more embodiments, user input can be received to indicate a rating of a piece of media associated with element 7412. For example, the user input can be received to indicate a rating of four of five stars of the piece of media associated with element 7412. For instance, selected rating elements 18012 can indicate the rating of four of five stars of the piece of media associated with element 7412.

In one or more embodiments, a recommendation engine can receive the rating of a piece of media associated with element 7412 and modify, based on the rating, a recommended list of media. For example, a recommendation engine (e.g., recommendation engine 3035, recommendation engine 4035, etc.) can receive the rating of four of five stars of the piece of media associated with element 7412 and modify, based on the rating, a recommended list of media. As illustrated, pieces of media associated with respective elements 17014-17020 may not have been rated by the user, according to one or more embodiments.

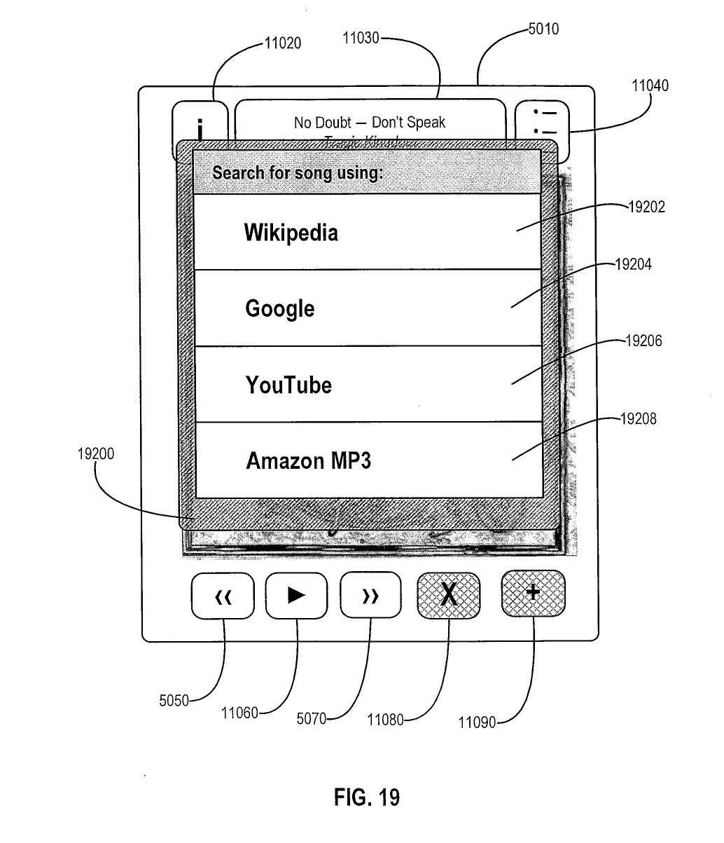

Turning now to FIG. 19, an exemplary diagram of a media player application is illustrated, according to one or more embodiments. As illustrated, display area or window 5010 can include elements 19200-19208, among others. In one or more embodiments, a search menu 19200 can be displayed in response to user input via element 11020, where further information associated with the piece of media associated with element 11030 could have been requested by a user. As shown, elements 19202-19208 can be selected to search for a song associated with element 11030 via Wikipedia, Google, YouTube, and Amazon MP3, respectively. For example, the user input can indicate that element 19206 is selected, and the song associated with element 11030 can be searched for video media and/or content associated with the song.

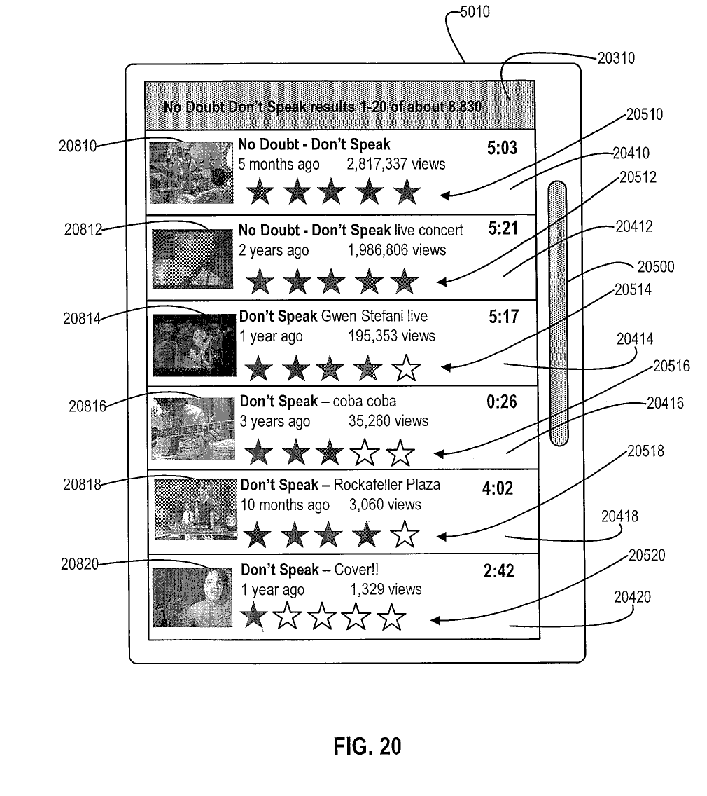

Turning now to FIG. 20, an exemplary diagram of a media player application is illustrated, according to one or more embodiments. As illustrated, display area or window 5010 can include elements 20310-20820, among others. In one or more embodiments, window 5010 can display a result from a search in response to user input selecting element 19206 (of FIG. 19). As illustrated, elements 20410-20420 can indicate information associated with and/or identifying one or more pieces of media. For example, elements 20410-20420 can indicate information associated with and/or identifying one or more videos on YouTube that can be associated with the piece of media associated with element 11030 (of FIG. 11 or 19). As shown, element 20310 can indicate information associated with the search in response to the user input. As illustrated, display area or window 5010 can include element 20500 which can be used as a scrollbar. For example, scrollbar 20500 can be used to scroll through and/or display, via window 5010, multiple elements associated with multiple pieces of media.

As shown, rating elements (e.g., stars) 20510-20520 can be associated with pieces of media associated with elements 20410-20420, respectively. In one or more embodiments, one or more servers (e.g., one or more of SCDs 1050) can receive input from one or more users to determine a rating for the pieces of media associated with elements 20410-20420. In one or more embodiments, rating elements 20510-20520 can indicate an average user rating for the pieces of media associated with elements 20410-20420. In one example, the piece of media associated with element 20410 can be associated with an average user rating of five stars of five stars, as indicated by rating elements 20510. In another example, the piece of media associated with element 20420 can be associated with an average user rating of one star of five stars, as indicated by rating elements 20520.

In one or more embodiments, elements 20810-20820 can be associated with the pieces of media associated with elements 20410-20420, respectively. In one example, each of elements 20810-20820 can include a graphic associated with a respective piece of media. For instance, element 20810 can include a frame of a video included in the piece of media associated with element 20410. In another example, each of elements 20810-20820 can include a video and/or graphics (e.g., multiple video frames, moving and/or motion picture(s), etc.) associated with a respective piece of media.

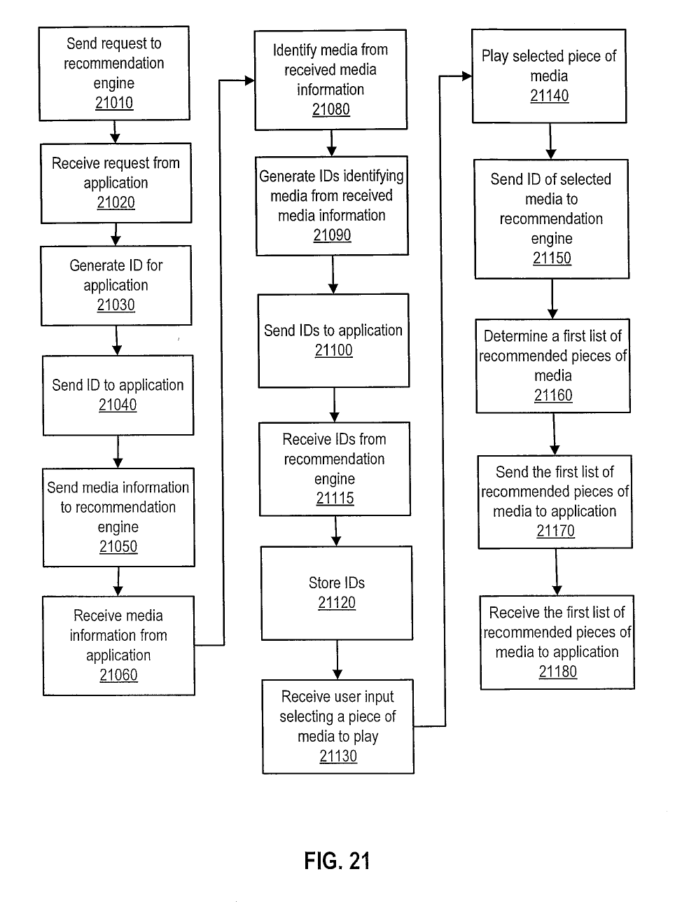

Turning now to FIG. 21, a method of generating a first list of recommended pieces of media is illustrated, according to one or more embodiments. At 21010, a request, from an application, can be sent to a recommendation engine, where the request can include a request to register with the recommendation engine. In one or more embodiments, APP 3037 can send the request to recommendation engine 3035 or recommendation engine 4035. In one or more embodiments, APP 3037 and recommendation engine 4035 can communicate via network 1010. At 21020, the request, from the application, can be received by the recommendation engine.

At 21030, an identification (ID) for the application can be generated and/or determined by the recommendation engine. In one or more embodiments, the ID can be used to identify one or more of a computing device (e.g., a computing device of CDs 1030-1039), an application (e.g., an application executing on a computing device of CDs 1030-1039), a processor (e.g., a processor included in a computing device of CDs 1030-1039), and a network interface (e.g., network interface 3040 of a computing device of CDs 1030-1039), among others. In one or more embodiments, network interface 3040 can include a subscriber identity module (SIM). For example, the SIM can securely store an international mobile subscriber identity (IMSI) which can include a unique number and/or identity associated with a global system for mobile communications (GSM) network and/or a universal mobile telecommunications system (UMTS) network. In one or more embodiments, a MSISDN (mobile subscriber ISDN (integrated services digital network) number, mobile station international ISDN number, or mobile international ISDN number) can be a number that can uniquely identify a subscription in a GSM mobile network and/or a UMTS mobile network. In one or more embodiments, the SIM can include and/or store identification information that can be used by the recommendation engine to generate and/or determine an ID for the application.

At 21040, the recommendation engine can send the ID to the application. At 21050, the application can send media information to the recommendation engine. For example, the media information can be associated with media library 3038. In one or more embodiments, the ID for the application can be sent to the recommendation engine with the media information. At 21060, the recommendation engine can receive the media information. In one or more embodiments, the ID for the application can be received by the recommendation engine with the media information. For example, the recommendation engine can use the ID for the application to associate the media information with a specific computing device (e.g., a specific computing device of CDs 1030-1039) and/or a specific application executing on a computing device.

At 21080, the recommendation engine can identify one or more pieces of media via the received media information. In one or more embodiments, identifying the one or more pieces of media can include one or more of an artist, a group, a song title, an album title, a video title, a movie title, a universal product code (UPC), and an international standard book number (ISBN) (e.g., for audio books), among others. In one or more embodiments, identifying the one or more pieces of media can include one or more fuzzy matching and/or audio and/or video fingerprinting methods, processes, and/or techniques to identify media with poor or non-existent tags (e.g., artist, title, album, etc.). In one or more embodiments, identifying the one or more pieces of media can include using a combination of fuzzy text matching logic and/or audio and/or video fingerprinting to identify the one or more pieces of media. At 21090, the recommendation engine can generate one or more identifications (IDs) that can be used to identify the one or more pieces of media. At 21100, the recommendation engine can send the IDs to the application, and the application can receive and/or store the IDs (e.g., in a memory such as memory 3030) at 21115.

At 21130, user input can be received selecting a piece of media to play. For example, APP 3037 can receive user input selecting the piece of media associated with element 5030 (of FIG. 5). At 21140, the selected piece of media can be played. For example, APP 3037 can play the piece of media associated with element 5030. At 21150, the application can send an ID associated with the selected piece of to the recommendation engine. At 21160, the recommendation engine can determine, based on the ID associated with the selected piece of media, a first list of recommended pieces of media.

At 21170, the recommendation engine can send the first list of recommended pieces of media to the application. In one or more embodiments, the first list of recommended pieces of media can be conveyed to the application via one or more corresponding IDs, where each of the one or more corresponding IDs corresponds to a piece of media. In one example, each of the one or more corresponding IDs corresponds to a piece of media included in media library 3038. In a second example, each of the one or more corresponding IDs corresponds to a piece of media not included in media library 3038. In a third example, each of the one or more corresponding IDs corresponds to a piece of media included in media library 3038 or not included in media library 3038. At 21180, the application can receive the first list of recommended pieces of media.

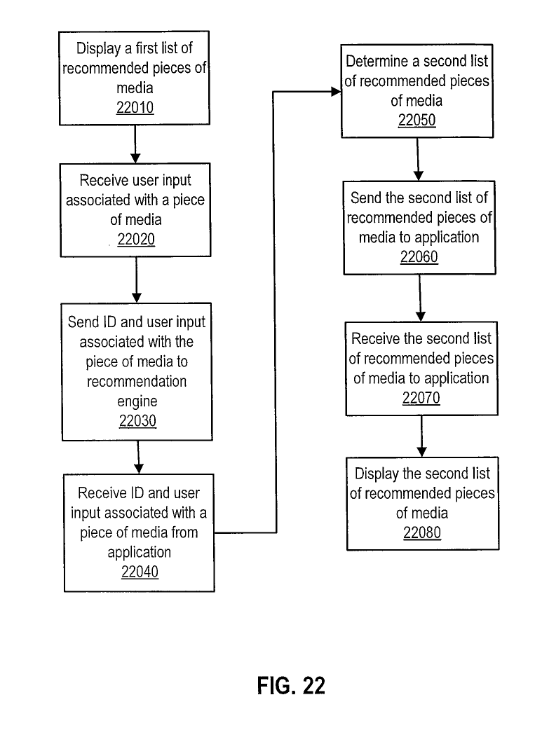

Turning now to FIG. 22, a method of generating a second list of recommended pieces of media is illustrated, according to one or more embodiments. At 22010, an application (e.g., APP 3037) can display a first list of recommended media. For example, the application can display the list of elements associated with the recommended media illustrated in FIG. 7 or FIG. 17. At 22020, the application can receive user input associated with a piece of media. In one example, the application can receive user input via one or more of elements 7612-7620 and 7712-7720 (of FIG. 7). In a second example, the application can receive user input via one or more of elements 7612-7629 and 17012-17020 (of FIG. 17). In another example, the application can receive user input in a passive fashion. For instance, a user allowing a piece of media to play for an amount of time can be equivalent to user input indicating a positive rating of the piece of media currently playing.

At 22030, the application can send an ID and user input associated with a piece of media to the recommendation engine. For example, the application can send, to the recommendation engine, an ID that corresponds to a piece of media and the received user input. In one instance, the received user input can include either a positive or negative indication associated with the recommended piece of media. In another instance, the user input can include a negative indication or a rating (e.g., an amount of stars) associated with the recommended piece of media. At 22040, the recommendation engine can receive the ID and the user input associated with the recommended piece of media.

At 22050, the recommendation engine can determine a second list of recommended pieces of media, based on the received ID and the user input associated with the recommended piece of media. At 22060, the recommendation engine can send the second list of recommended pieces of media to the application. In one or more embodiments, the second list of recommended pieces of media can be conveyed to the application via one or more corresponding IDs, where each of the one or more corresponding IDs corresponds to a piece of media. In one example, each of the one or more corresponding IDs corresponds to a piece of media included in media library 3038. In a second example, each of the one or more corresponding IDs corresponds to a piece of media not included in media library 3038. In a third example, each of the one or more corresponding IDs corresponds to a piece of media included in media library 3038 or not included in media library 3038. At 22070, the application can receive the second list of recommended pieces of media. At 22080, the application can display the second list of recommended media. For example, the application can display the list of elements associated with the recommended media illustrated in FIG. 10.

In one or more embodiments, one or more of the methods illustrated in FIGS. 21 and 22 can be repeated multiple times by a user using CD 1030 or each of multiple users using corresponding CDs 1030-1039. As a number of iterations of the one or more methods illustrated in FIGS. 21 and 22 increases, the recommendations determined by the recommendation engine can become better and/or can provide better correlations between/among multiple pieces of media (according to some metric), according to one or more embodiments. In one example, the recommendation can store multiple user inputs associated with multiple pieces of media and use the ratings and/or correlations between/among multiple pieces of media to determine multiple recommended lists of pieces of media.

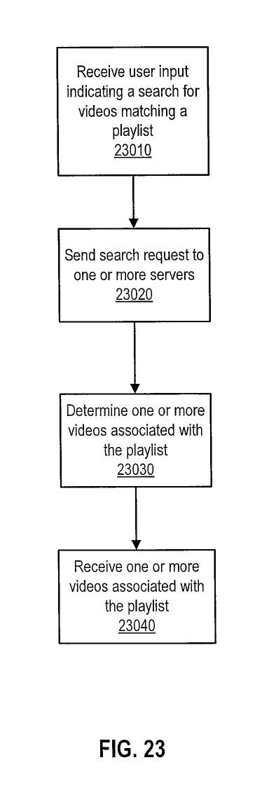

Turning now to FIG. 23, a method of using a playlist to search for videos is illustrated, according to one or more embodiments. At 23010, user input can be received, where the user input indicates a search for videos corresponding to songs of a playlist. For example, APP 3037 can receive the user input. At 23020, a request for videos corresponding to songs of the playlist can be sent to one or more servers. For example, APP 3037 can send the request for videos corresponding to songs of the playlist can be sent to one or more SCDs 1050-1052. At 23030, one or more videos that correspond to one or more songs of the playlist can be determined. In one example, videos for all songs of the playlist can be determined. In another example, one or more videos for one or more, but not all, songs of the playlist can be determined. At 23040, one or more videos associated with the playlist can be received. For example, APP 3037 can receive the determined one or more videos from one or more of SCDs 1050-1052 via network 1010.

In one or more embodiments, receiving the determined one or more videos associated with the playlist can include receiving the determined one or more videos in a streaming format. For example, a portion of a video can be downloaded and displayed, and after the portion is displayed, the portion is not stored in a memory (e.g., memory 3030) or is stored in a portion of the memory that is not associated with a portion of memory that is not necessarily allocated for an application, storage, and/or system operation. For instance, the portion of the memory can be overwritten by another application at any time after displaying the corresponding portion of the video. For example, the one or more videos can be streamed from one or more streaming services (e.g., YouTube, Google Video, Dailymotion, Globo Video, MyVideo, iFilm, Yahoo Video, etc.). In one or more embodiments, receiving the determined one or more videos associated with the playlist can include receiving the determined one or more videos from a fee based service. In one example, receiving the determined one or more videos can include receiving the determined one or more videos from iTunes, among others, where the determined one or more videos can be downloaded for one or more fees.

One or more modifications and/or alternative embodiments of one or more aspects of the disclosure may be apparent to those skilled in the art in view of this description. Thus, this description is to be understood as illustrative only and is for the purpose of teaching those skilled in the art the general manner of carrying out the embodiments described herein. In one example, one or more of CDs 1301-1039 can include one or more same or similar structures and/or functionalities of CD 1030 and can be used in place of CD 1030 in the description. In a second example, one or more of SCDs 1051 and 1052 can include one or more same or similar structures and/or functionalities of SCD 1050 and can be used in place of SCD 1050 in the description. In one or more embodiments, one or more of the method elements described herein and/or one or more portions of an implementation of a method element can be performed in varying orders, can be performed concurrently with one or more of the other method elements and/or one or more portions of an implementation of a method element, or can be omitted. Additional method elements can be performed as desired. In one or more embodiments, concurrently can mean simultaneously. In one or more embodiments, concurrently can mean apparently simultaneously according to some metric. For example, two or more method elements and/or two or more portions of an implementation of a method element can be performed such that they appear to be simultaneous to a human. In one or more embodiments, one or more of the system elements described herein may be omitted and additional system elements can be added as desired. In one or more embodiments, elements and materials may be substituted for those illustrated and described herein, parts and processes may be reversed, and certain features of the disclosure may be utilized independently, all as would be apparent to one skilled in the art after having the benefit of this description.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A method of creating a media playlist on a user computing device comprising:
selecting one or more media files to play on the computing device;
collecting data regarding the one or more selected media files;
automatically determining one or more attributes associated with one or more of the selected media files;
automatically generating a playlist comprising one or more additional media files that were not selected by a user of the user computing device.

2. The method of claim 1, wherein the user of the user computing device selects one or more media files by playing the media file for a predetermined amount of time.

3. The method of claim 1, further comprising making a negative indication of a media file, wherein a negative indication is used to exclude media having attributes the same or similar to the attributes of the negative selection from the generated playlist.

4. The method of claim 3, wherein a negative selection is made by skipping a media file during playback of a plurality of media files.

5. The method of claim 3, wherein a negative selection is made by playing a selected media file for less than a predetermined amount of time.

6. The method of claim 1, wherein the media in the generated playlist is selected from media on the computing device.

7. The method of claim 1, wherein media in the generated playlist is selected from media on a server computing device coupled to the user computing device.

8. The method of claim 1, wherein media in the generated playlist is selected from media from an online source.

9. The method of claim 1, wherein media from the generated playlist is placed in a queue to be played after the user plays a selected media file.

10. The method of claim 1, further comprising updating the playlist based on information entered by the user regarding one or more of the additional media selections.

11. The method of claim 1, further comprising updating the playlist based on affinities between the user selected media and other media.

12. The method of claim 1, wherein one or more attributes associated with one or more of the selected media files are saved on the computing device, and wherein the playlist is generated when the computing device is coupled to a server computing device that has access to media files that are not on the computing device.

13. The method of claim 1, wherein one or more of the selected media files are music files.

14. The method of claim 1, wherein one or more of the selected media files are video files.

15. The method of claim 1, wherein one or more of the selected media files are music files, and wherein generating the playlist comprises adding video associated with the music to the playlist.

16. The method of claim 1, wherein the computing device is a mobile wireless telephone.

17. The method of claim 1, wherein the computing device is a portable media player.

18. The method of claim 1, further comprising providing a positive indication and/or negative indication for one or more of the additional media files.

19. The method of claim 1, further comprising a list of media file recommendations for addition to the playlist.

20. The method of claim 19, further comprising altering the list of media file recommendations based on a selection of one or more of the recommended media files by the user.

21. A computing device comprising a processor, wherein the processor is operable to execute program instructions, and wherein the program instructions are operable to perform a method of creating a media playlist on the computing device, the method comprising:
selecting one or more media files to play on the computing device;
collecting data regarding the one or more selected media files;
automatically determining one or more attributes associated with one or more of the selected media files;
automatically generating a playlist comprising one or more additional media files that were not selected by a user of the user computing device.

22-40. (canceled)

41. A tangible, computer readable medium comprising program instructions, wherein the program instructions are computer-executable to implement a method of creating a media playlist on a user computing device, the method comprising:
selecting one or more media files to play on the computing device;
collecting data regarding the one or more selected media files;
automatically determining one or more attributes associated with one or more of the selected media files;
automatically generating a playlist comprising one or more additional media files that were not selected by a user of the user computing device.

42-60. (canceled)
